(19) United States
(12) Patent Application Publication
(10) Pub. No.: US 2012/0027303 A1
(43) Pub. Date: Feb. 2, 2012

(54) AUTOMATED MULTIPLE IMAGE PRODUCT SYSTEM

(75) Inventor: Ronald S. Cok, Rochester, NY (US)

(73) Assignee: Eastman Kodak Company, Rochester, NY (US)

(21) Appl. No.: 12/844,111

(22) Filed: Jul. 27, 2010

(51) Int. Cl. G06K 9/46; G06F 15/16

(52) U.S. Cl. 382/190; 709/203

(57) ABSTRACT

A computer system for making a multi-image product comprising a server connected to one or more remote clients through a network. Several software portions executable by the server or client, or any combination thereof, are provided for selecting first and second dates to define a date range and for selecting a theme, for retrieving a plurality of digital images that includes digital images taken within the date range, for segmenting the digital images into distinct events, each distinct event including one or more different digital images, for identifying distinct events corresponding to the theme, for selecting at least one digital image from each of at least two distinct events, and for incorporating the selected images into a multi-image product.

### CROSS REFERENCES TO RELATED APPLICATIONS

U.S. patent application Ser. No. 12/______, (Docket 96382) entitled “AUTOMATED IMAGE-SELECTION METHOD”;

U.S. patent application Ser. No. 12/______, (Docket 96454) entitled “AUTOMATED IMAGE-SELECTION SYSTEM”; and

U.S. patent application Ser. No. 12/______, (Docket 96455) entitled “AUTOMATED MULTIPLE IMAGE PRODUCT METHOD”, filed concurrently herewith are assigned to the same assignee hereof, Eastman Kodak Company of Rochester, N.Y., and contains subject matter related, in certain respect, to the subject matter of the present application. The above-identified patent applications are incorporated herein by reference in their entireties.

U.S. patent application Ser. No. 12/767,837, (Docket 96194) entitled “AUTOMATED TEMPLATE LAYOUT METHOD”, filed Apr. 27, 2010 and U.S. patent application Ser. No. 12/767,861, (Docket 96253) entitled “AUTOMATED TEMPLATE LAYOUT SYSTEM”, filed Apr. 27, 2010 are assigned to the same assignee hereof, Eastman Kodak Company of Rochester, N.Y., and contains subject matter related, in certain respect, to the subject matter of the present application. The above-identified patent applications are incorporated herein by reference in their entireties.

### FIELD OF THE INVENTION

The present invention relates to computer-implemented selection of images for multi-image products representative of a plurality of diverse events.

### BACKGROUND OF THE INVENTION

Digital images record events for individuals and groups and are often used in designing and making gifts and mementos. Many individuals accumulate large collections of digital images, making the selection of digital images for a particular photo-based product, for example, a calendar or a photo-book, difficult. While selecting images for a specific event can be relatively straightforward, selecting images for products that encompass diverse events can be more problematic. Moreover, the longer the period of time over which digital images are taken, the more difficult and tedious it can be to select a suitable collection of images representative of an event or events. In particular, it can be desirable to select a diverse set of images representative of a variety of events. For example, calendars, some photo-books, and some photo-collages are multi-image products that can include digital images representative of diverse events.

Methods for automatically organizing images in a collection into groups of images representative of an event are known. It is also known to divide groups of images representative of an event into smaller groups representative of sub-events within the context of a larger event. For example, images can be segmented into event groups or sub-event groups based on the times at which the images in a collection were taken. U.S. Pat. No. 7,366,994 describes organizing digital objects according to a histogram timeline in which digital images can be grouped by time of image capture. U.S. Patent Publication No. 2007/0008321 describes identifying images of special events based on time of image capture.

Semantic analyses of digital images are also known in the art. For example, U.S. Pat. No. 7,035,467 describes a method for determining the general semantic theme of a group of images using a confidence measure derived from feature extraction. Scene content similarity between digital images can also be used to indicate digital image membership in a group of digital images representative of an event. For example, images having similar color histograms can belong to the same event.

While these methods are useful for sorting images into event groups, they do not address the need for organizing diverse collections of images or address the need in some image products for arranging digital images representing a diverse set of events.

U.S. Patent Application 2007/0177805 describes a method of searching through a collection of images, includes providing a list of individuals of interest and features associated with such individuals; detecting people in the image collection; determining the likelihood for each listed individual of appearing in each image collection in response to the people detected and the features associated with the listed individuals; and selecting in response to the determined likelihoods a number of images such that each individual from the list appears in the selected images. This enables a user to locate images of particular people but does not necessarily assist in finding suitable images for a particular set of diverse events.

U.S. Pat. No. 6,389,181 discusses photo-collage generation and modification using image processing by obtaining a digital record for each of a plurality of images, assigning each of the digital records a unique identifier and storing the digital records in a database. The digital records are automatically sorted using at least one date type to categorize each of the digital records according at least one predetermined criteria. The sorted digital records are used to compose a photo-collage. The method and system employ data types selected from digital image pixel data; metadata; product order information; processing goal information; or a customer profile to automatically sort data, typically by culling or grouping, to categorize images according to either an event, a person, or chronology. While this assists in sorting digital images, it does not necessarily assist in finding suitable images for a desired set of diverse events.

There is a need, therefore, for an improved method for selecting digital images for multi-image, multi-event products.

### SUMMARY OF THE INVENTION

In accordance with a preferred embodiment of the present invention, there is provided a computer system for making a multi-image product. The system comprises a server connected to one or more remote clients through a network. Several software portions executable by the system are provided for selecting first and second dates to define a date range and for selecting a theme, for retrieving a plurality of digital images that includes digital images taken within the date range, for segmenting the digital images into distinct events, each distinct event including one or more different digital images, for identifying distinct events corresponding to the theme, for selecting at least one digital image from each of at least two distinct events, and for incorporating the selected images into a multi-image product. The multi-image product is communicated, sent, transmitted or otherwise delivered to a person.

In accordance with another preferred embodiment of the present invention, there is provided a computer system for automatically designing a multi-image product, comprising a memory for storing a plurality of digital image files, each digital image file including a digital image and metadata defining the included digital image, a user interface for selecting first and second dates to define a date range, and for selecting a theme, wherein the date range and the theme are stored in the memory. A program comprising several portions, subroutines, procedures, objects, or functions is provided for reading the metadata to find ones of the digital image files having both capture dates that are within the date range and image elements corresponding to the theme, for sorting the digital image files into distinct event groups, each distinct event group including one or more different digital image files, for selecting at least one digital image files from each of at least two distinct event groups, and for arranging the selected images into a multi-image product. As before, the multi-image product is communicated, sent, transmitted or otherwise delivered to a person.

Preferred embodiments of the present invention have the advantage that the process of making a multi-image product representative of diverse events is made simpler, faster, and provides a more satisfactory result. These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale neither with respect to relative size, angular relationship, or relative position nor to any combinational relationship with respect to interchangeability, substitution, or representation of an actual implementation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 illustrates a computer system for use in a preferred embodiment of the present invention;

FIG. 2 illustrates a user operating a computer system in a preferred embodiment of the present invention;

FIG. 3 illustrates a computer system including remote client computers connected by a computer network to a server computer in a preferred embodiment of the present invention;

FIG. 4 is a flow diagram illustrating a method according to an embodiment of the present invention;

FIG. 5 is a flow diagram illustrating an alternative method according to an embodiment of the present invention;

FIG. 6 is a flow diagram illustrating another method according to an embodiment of the present invention;

FIG. 7 is a flow diagram illustrating a method according to an embodiment of the present invention;

FIG. 8 is a flow diagram illustrating yet another method according to an embodiment of the present invention;

FIG. 9 is a flow diagram illustrating a portion of a method according to an embodiment of the present invention;

FIG. 10 is a flow diagram illustrating a portion of a method according to an embodiment of the present invention;

FIG. 11 illustrates recorded metadata tags; and

FIG. 12 illustrates derived metadata tags.

### DETAILED DESCRIPTION OF THE INVENTION

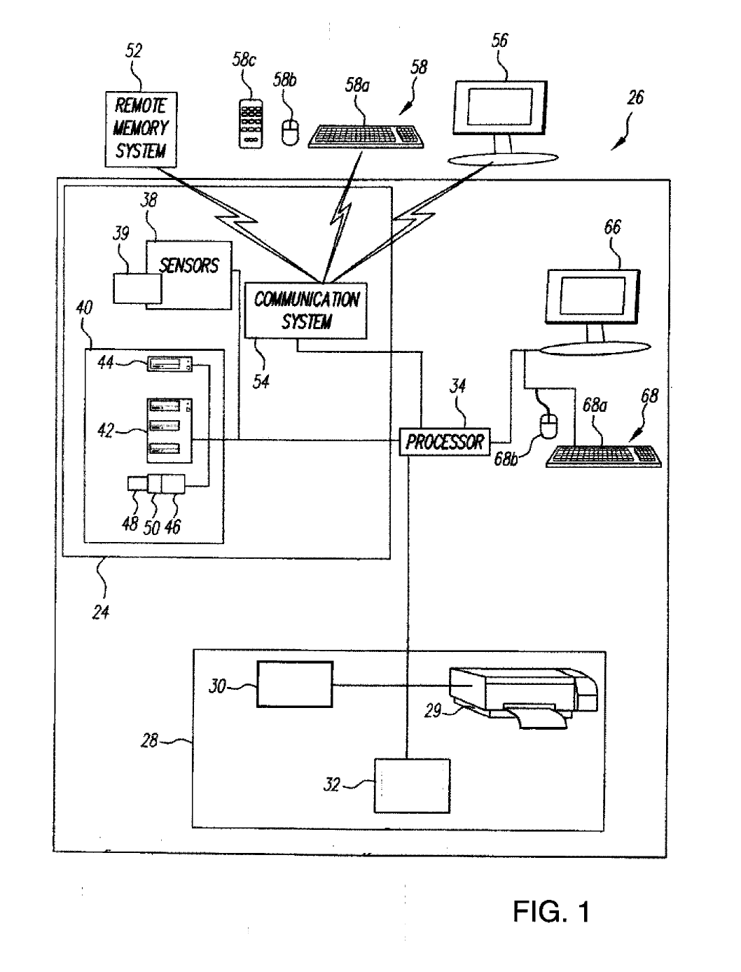

FIG. 1 illustrates a first embodiment of an electronic system 26, a computer system, for implementing certain embodiments of the present invention for automatically generating image-enhanced products. In the embodiment of FIG. 1, electronic computer system 26 comprises a source of content and program data files 24 such as software applications, association sets, image files, and image season information. The electronic computer system 26 can include various memory and storage devices 40, a wired user input system 68 as well as a wireless input system 58, and an output system 28, all communicating directly or indirectly with processor 34. Although not shown processor 34 is meant to illustrate typical processor system and chip components such as instruction and execution registers, an ALU, various levels of cache memory, etc. The source of program and content data files 24, user input system 68, or output system 28, and processor 34 can be located within a housing (not shown). In other embodiments, circuits and systems of the source of content and program data files 24, user input system 68 or output system 28 can be located in whole or in part outside of a housing.

The source of content or program data files 24 can include any form of electronic, optical, or magnetic storage such as optical discs, storage discs, diskettes, flash drives, etc., or other circuits or systems that can supply digital data to processor 34 from which processor 34 can load software, association sets, image files, and image season information, and derived and recorded metadata. In this regard, the content and program data files can comprise, for example and without limitation, software applications, a still-image data base, image sequences, a video data base, graphics, and computer generated images, image information associated with still, video, or graphic images, and any other data necessary for practicing embodiments of the present invention as described herein. Source of content data files 24 can optionally include devices to capture images to create image data files by use of capture devices located at electronic computer system 20 and/or can obtain content data files that have been prepared by or using other devices or image enhancement and editing software. In the embodiment of FIG. 1, sources of content or program data files 24 include sensors 38, a memory and storage system 40 and a communication system 54.

Sensors 38 can include one or more cameras, video sensors, scanners, microphones, PDAs, palm tops, laptops that are adapted to capture images and can be coupled to processor 34 directly by cable or by removing portable memory 39 from these devices and/or computer systems and coupling the portable memory 39 to slot 46. Sensors 38 can also include biometric or other sensors for measuring physical and mental reactions. Such sensors can include, but are not limited to, voice inflection, body movement, eye movement, pupil dilation, body temperature, and p4000 wave sensors.

Memory and storage 40 can include conventional digital memory devices including solid state, magnetic, optical or other data storage devices, as mentioned above. Memory 40 can be fixed within computer system 26 or it can be removable and portable. In the embodiment of FIG. 1, computer system 26 is shown having a hard disk drive 42, which can be an attachable external hard drive, which can include an operating system for electronic computer system 26, and other software programs and applications such as the program algorithm embodiments of the present invention, derived and recorded metadata, image files, image attributes, software applications, and a digital image data base. A disk drive 44 for a removable disk such as an optical, magnetic or other disk memory (not shown) can also include control programs and software programs useful for certain embodiments of the present invention, and a memory card slot 46 that holds a removable portable memory 48 such as a removable memory card or flash memory drive or other connectable memory and has a removable memory interface 50 for communicating with removable memory 48. Data including, but not limited to, control programs, derived and recorded metadata, digital image files, image attributes, software applications, digital images, and metadata can also be stored in a remote memory system 52 such as a personal computer, computer network, a network connected server, or other digital system.

In the embodiment shown in FIG. 1, computer system 26 has a communication system 54 that in this embodiment can be used to communicate with an optional remote input 58, remote memory system 52, an optional remote display 56, for example by transmitting image-product designs with or without merged images and receiving from remote memory system 52, a variety of control programs, derived and recorded metadata, image files, image attributes, and software applications. Although communication system 54 is shown as a wireless communication system, it can also include a modem for coupling to a network over a communication cable for providing to the computer system 26 network and remote memory system 52 access. A remote input station including a remote display 56 and/or remote input controls 58 (also referred to herein as “remote input 58) can communicate with communication system 54 wirelessly as illustrated or, again, can communicate in a wired fashion. In a preferred embodiment, a local input station including either or both of a local display 66 and local user input controls 68 (also referred to herein as “local user input 68”) is connected to processor 34 which is connected to communication system 54 using a wired or wireless connection.

Communication system 54 can comprise for example, one or more optical, radio frequency or other transducer circuits or other systems that convert data into a form that can be conveyed to a remote device such as remote memory system 52 or remote display 56 using an optical signal, radio frequency signal or other form of signal. Communication system 54 can also be used to receive a digital image and other data, as exemplified above, from a host or server computer or network (not shown), a remote memory system 52 or a remote input 58. Communication system 54 provides processor 34 with information and instructions from signals received thereby. Typically, communication system 54 will be adapted to communicate with the remote memory system 52 by way of a communication network such as a conventional telecommunication or data transfer network such as the interne, and peer-to-peer; cellular or other form of mobile telecommunication network, a local communication network such as wired or wireless local area network or any other conventional wired or wireless data transfer system.

User input system 68 provides a way for a user of computer system 26 to provide instructions to processor 34, such instructions comprising automated software algorithms of particular embodiments of the present invention. This software also allows a user to make a designation of content data files, such as designating digital image files, to be used in automatically generating an image-enhanced output image product according to an embodiment of the present invention and to select an output form for the output product. User controls 68a, 68b or 58a, 58b in user input system 68, 58, respectively, can also be used for a variety of other purposes including, but not limited to, allowing a user to arrange, organize and edit content data files, such as coordinated image displays, to be incorporated into the image output product, for example, by incorporating image editing software in computer system 26 which can be used to override design automated image output products generated by computer system 26, as described below in certain preferred method embodiments of the present invention, to provide information about the user, to provide annotation data such as text data, to identify characters in the content data files, and to perform such other interactions with computer system 26 as will be described later.

In this regard user input system 68 can comprise any form of device capable of receiving an input from a user and converting this input into a form that can be used by processor 34. For example, user input system 68 can comprise a touch screen input 66, a touch pad input, a multi-way switch, a stylus system, a trackball system, a joystick system, a voice recognition system, a gesture recognition system, a keyboard 68a, mouse 68b, a remote control or other such systems. In the embodiment shown in FIG. 1, electronic computer system 26 includes an optional remote input 58 including a remote keyboard 58a, a remote mouse 58b, and a remote control 58c. Remote input 58 can take a variety of forms, including, but not limited to, the remote keyboard 58a, remote mouse 58b or remote control handheld device 58c illustrated in FIG. 1. Similarly, local input 68 can take a variety of forms. In the embodiment of FIG. 1, local display 66 and local user input 68 are shown directly connected to processor 34.

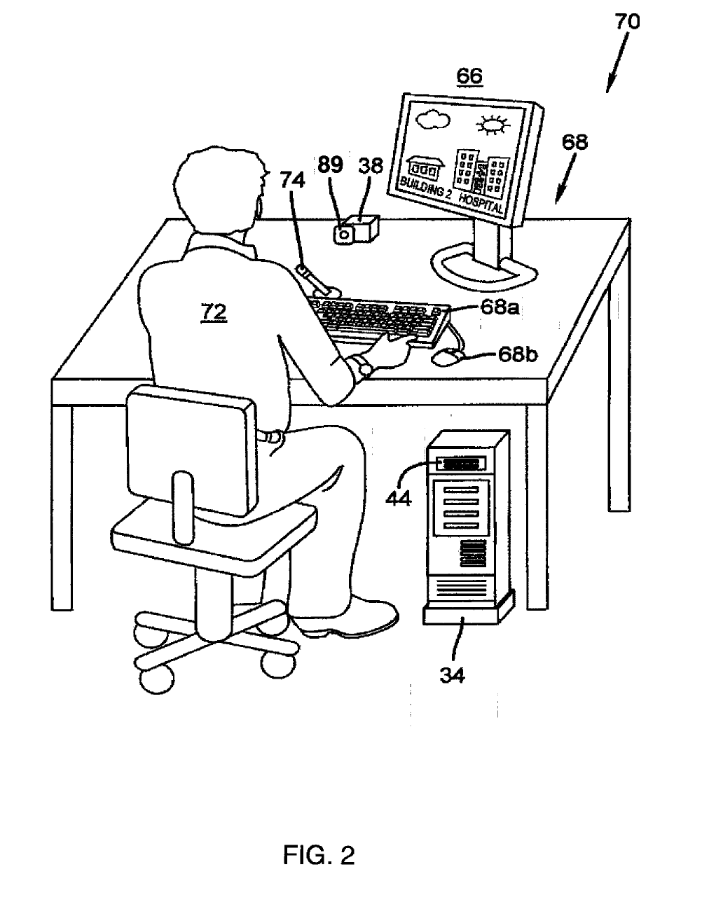

As is illustrated in FIG. 2, computer system 26 and local user input system 68 can take the form of an editing studio or kiosk 70 (hereafter also referred to as an “editing area 70”), although this illustration is not intended to limit the possibilities as described in FIG. 1 of editing studio implementations. In this illustration, a user 72 is seated before a console comprising local keyboard 68a and mouse 68b and a local display 66 which is capable, for example, of displaying multimedia content. As is also illustrated in FIG. 2, editing area 70 can also have sensors 38 including, but not limited to, camera or video sensors 38 with built in lenses 89, audio sensors 74 and other sensors such as, for example, multispectral sensors that can monitor user 72 during a user or production session.

Output system 28 (FIG. 1) is used for rendering images, text, completed or uncompleted digital image output products, or other graphical representations in a manner that allows an image output product to be generated. In this regard, output system 28 can comprise any conventional structure or system that is known for printing, displaying, or recording images, including, but not limited to, printer 29. For example, in other embodiments, output system 28 can include a plurality of printers 29, 30, 32, and types of printers, including thermal printers, electro-photographic printers, color paper printers, and transfer machines capable of screen printing t-shirts and other articles. Processor 34 is capable of sending print commands and print date to a plurality of printers or to a network of printers. Each printer of the plurality of printers can be of the same or a different type of printer, and each printer may be able to produce prints of the same or a different format from others of the plurality of printers. Printer 29 can record images on a tangible surface, such as on, for example, various standard media or on clothing such as a T-shirt, using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology such as in thermal printer 30, drop-on-demand ink-jet technology and continuous inkjet technology. For the purpose of the following discussions, printers 29, 30, 32 will be described as being of a type that generates color images. However, it will be appreciated that this is not necessary and that the claimed methods and apparatuses herein can be practiced with printers 29, 30, 32 that print monotone images such as black and white, grayscale or sepia toned images.

In certain embodiments, the source of content data files 24, user input system 68 and output system 28 can share components. Processor 34 operates system 26 based upon signals from user input system 58, 68, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit chip, or a series of discrete chip components.

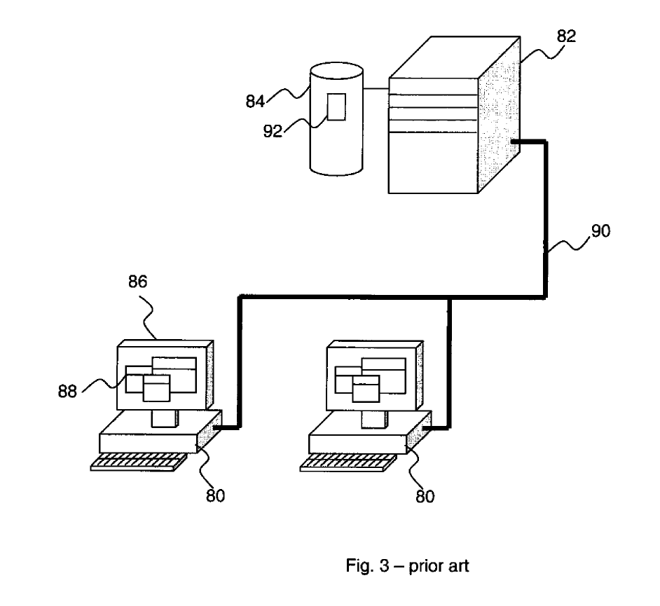

Referring to FIG. 3, a prior-art computer network 90, for example the internet, can interconnect a plurality of client computers 80 remote from a server computer 82. Each client computer 80 can include a display 86 having software that executes a graphic user interface 88, for example using windows. The server computers 82 can include storage 84 that can store digital images and software executable programs 92. Users can interact with the client computer's graphic interface 88 to execute programs downloaded from the server 82 to specify or select products in an internet-mediated business. In particular, digital images can be stored on the server computer 82 and transmitted to a client computer 80 in response to user commands. Likewise, image processing or layout programs can be downloaded from the server computer 82 to a client computer 80, thereby enabling a user operating the remote client computer 80 to specify a digital image product.

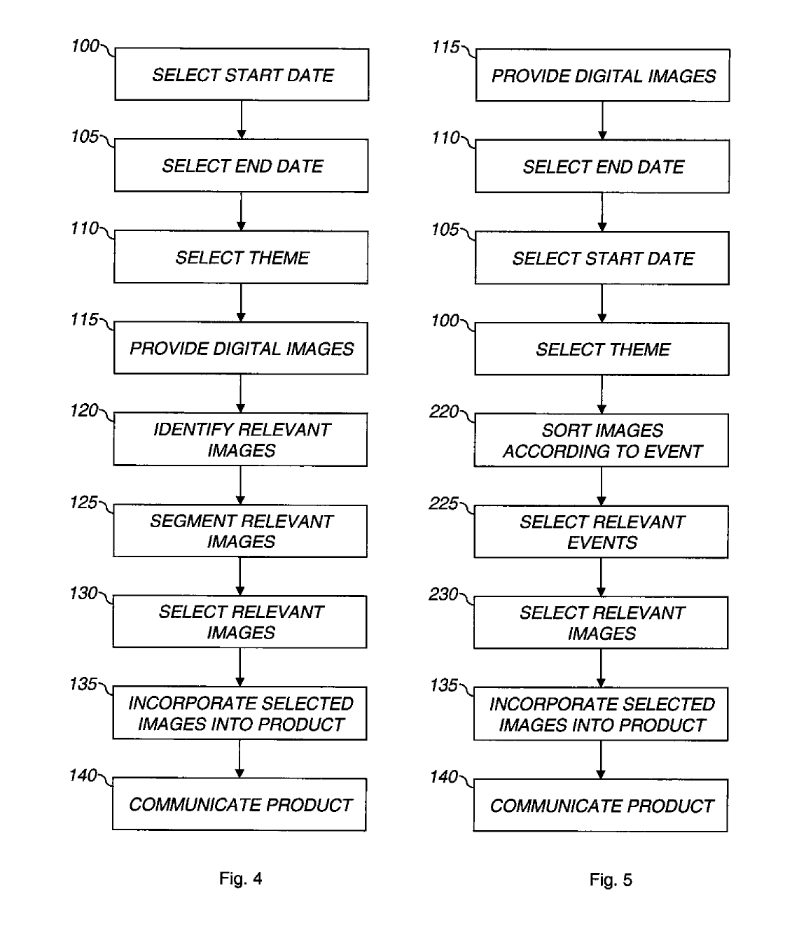

One type of image product can include digital images from a plurality of different distinct events over a specified period of time. Each distinct event can include multiple images. For example, a photo book having multiple images from each of several different distinct events occurring over a specified time period, such as a year, can make a popular gift or memento. Referring to FIG. 4, a programmed method of automatically making such a multi-image multi-event product can comprise the steps of selecting a start date in step 100 and an end date in step 105 to define a date range and selecting a theme in step 110. A plurality of digital images that includes digital images taken within the date range are automatically searched, identified, and provided in step 115. Relevant digital images that are within the date range and relevant to the theme are identified in step 120. Suitably themed images within the date range can be identified by analyzing image metadata and pixels. For example, those images that have metadata identifying the time of capture and for which the time of capture falls within the date range are presumed to be within the date range. Additional metadata identifying the subject or event recorded can provide information relevant to the theme of the image. Pixel analysis can identify objects within the scene that are associated with themes. In particular, face recognition can be employed to identify the main character, and other individuals, within a scene. Images having objects that are associated with the theme can be identified as relevant to the theme. The relevant digital images are automatically sorted into distinct events based on the search in step 125, each distinct event including one or more different relevant digital images. At least one relevant digital image is automatically selected in step 130 from each of at least two different distinct events and the selected images are incorporated into a multi-image, multi-event product in step 135. The resulting multi-image multi-event product can be communicated in step 140, for example by automatically printing the multi-image multi-event product or by automatically emailing the multi-image multi-event product or emailing a reference to a stored multi-image multi-event product. The reference can include a hyperlink to the product for viewing on a computer display, for example, display 86.

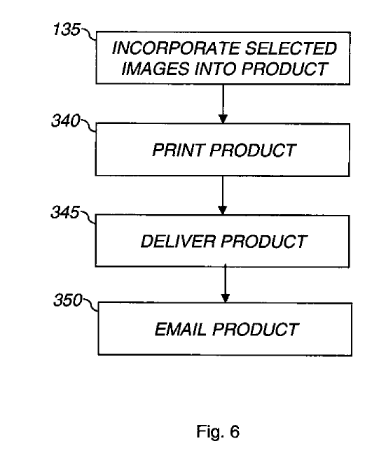

The computer system implemented process steps of FIG. 4 specify that relevant digital images are identified before the identified digital images are segmented into events. In an alternative process, the digital images can be programmably grouped or sorted into events, relevant events selected, and relevant images selected from the relevant events. Moreover, other steps such as selecting dates and a theme can be performed in other temporal orders, as will be apparent to one skilled in the computer science arts. For example, referring to FIG. 5, using the same numbered elements to refer to similar process steps as in FIG. 4, a method of making a multi-image multi-event product can comprise the steps of providing digital images in step 115, selecting an end date in step 110 and a start date in step 105 to define a date range and selecting a theme in step 100. The digital images are grouped into distinct events in step 220, each event including one or more different digital images. Relevant distinct events can be selected in step 225 and relevant digital images from within the relevant events selected in step 230. The selected relevant digital images are incorporated into a multi-image, multi-event product in step 135. For example, the selected relevant digital images can be incorporated into a multi-image, multi-event product by locating one image from each event on a printed page of a photo-collage. In another example, multiple images from one event can be located on a page of a photo-book. Each page in the photo-book can include images associated with one event. Alternatively, images from each event can take multiple pages while images from separate events are located on separate pages. The resulting multi-image multi-event product can be communicated in step 140, for example by printing the multi-image multi-event product or by emailing the multi-image multi-event product or emailing a reference to a stored multi-image multi-event product (FIG. 6). If only images within the date range and relevant to the theme are provided and sorted, it is possible that all of the segmented events are relevant, in which case the selecting relevant events step is optional.

As implemented herein, a theme is a central character, organization, or topic whose activities over the time period defined by the date range are captured in the relevant digital images. Multiple distinct events within the time period are recorded by the digital images and included in the multi-image, multi-event product. The term distinct events is meant to describe events relating to the theme but that record different activities, which occur at different times, and can also occur at different locations or include different characters. The multi-image, multi-event product can be communicated by printing the multi-image, multi-event product, for example as prints or images in a photo-book and viewed or shared with others. The multi-image, multi-event product can also be communicated by electronically transmitting an electronic specification of the multi-image, multi-event product or by electronically transmitting an electronic location, such as a URL or a hyperlink, of an electronic representation of the multi-image, multi-event product. The multi-image, multi-event product can be a multi-page image product, for example a photo-book, with multiple images on each page and distinct events illustrated on different pages. The date range can be, but is not limited to, a calendar year with dates that are one year apart, either one that runs from January through December or that corresponds to a school year or activity season such as a sporting season or club season or, generally, to the beginning and end of a period of activities related to a group.

The present invention includes capturing and storing images of distinct events that take place at different times, hence relevant digital images can be sorted into distinct events that took place at different times. In one embodiment of the present invention, images of the distinct events at different times span the date range. As used herein, digital images of distinct events that span a date range include images from at least two distinct events, a first distinct event that is closer in time to the beginning of the date range than it is to a second distinct event and a second distinct event that is closer in time to the end of the date range than it is to the first distinct event.

The images of distinct events of the present invention are related to a theme. A wide variety of themes can be employed according to various embodiments of the present invention. For example, a theme can correspond to significant events of an individual's life, the events of a sports team, the events of a group of people, the events of a club, the events of a musical group, the events of a theater group, the events of a political group, the events of an organization, or the events of a social group. Events associated with a calendar season can be used, for example a sports team season, holiday seasons, and weather seasons such as Winter, Spring, Summer, and Fall. Themes included in the present invention are not limited to the above topics.

In order to enhance the quality of the multi-image, multi-event product, duplicate or dud images can be removed from the plurality of digital images, the digital images taken within the date range, the relevant digital images, or the selected digital images. Algorithms for detecting such duplicate or dud images are known in the art. Likewise, image quality metrics can be employed to provide a digital image quality rating for each digital image and more highly rated digital images than low-rated digital images can be preferentially included in an image product.

Digital images relevant to the selected theme can be found using a number of computer implemented methods. Historical data associating dates with events can be useful. Likewise, the recognition of persons (e.g. using face recognition) in a digital image can be useful in associating a digital image with a theme, for example a biographical theme. Meta-data associated with a digital image can also be useful. Image analysis can be used to identify relevant objects and activities within a digital image.

In a preferred embodiment of the present invention, the activities of a group or individual over the span of a calendar year can be a theme. Accordingly, a set of events related to the group or individual that took place over the year can be programmably incorporated into the multi-image multi-event product. By recognizing common individuals or objects that are relevant to many or all of the thematically related events in an image, images can be selected that can be incorporated, for example, into a photo-collage or photo-book. For example, sports-team members can wear distinctive clothing that is associated with a sporting season. The clothing can then be automatically recognized in the desired images with image processing algorithms and the desired images incorporated into the multi-event, multi-image product. A variety of distinct events taken through the year can enhance the multi-image multi-event product and it can be useful, therefore, to identify the season in which a digital image was taken.

The programmed identification of a season in which a digital image was made can be performed by programming an automatic analysis of the pixels in the digital image. This digital image analysis can identify objects, colors, textures, and shapes within an image. The objects, colors, textures, and shapes can be associated with one or more of a plurality of seasons and can therefore indicate which season is most likely represented within a digital image. The objects, colors, textures, and shapes associated with a season can be stored as elements in an association set. Therefore, automatically analyzing the pixels in a digital image to find in each of the one or more digital images an item from the association set can provide a way to assign each of the one or more digital images to a season corresponding to the item from the association set.

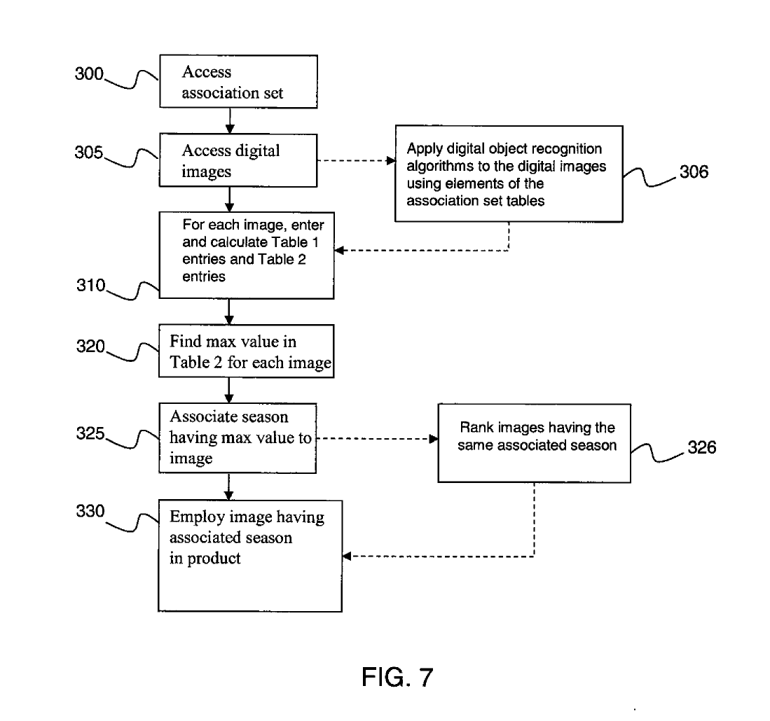

Referring to FIG. 7, a flow chart describing a computer implemented method of matching a digital image to a season is illustrated. In step 300, an association set, such as described below with reference to Table 1 and Table 2, is accessed by the computer system. The association set can be previously stored in the computer system or provided by a user via portable memory or otherwise accessible over a local or wide area network or over the internet by computer system 26 (FIG. 1). A digital image set comprising digital images from which suitable digital images are to be selected is selected in step 305. Similar to the step of accessing an association set, the digital images are selected from a group of previously stored digital images in the computer system or provided by a user via portable memory or otherwise accessible over a local or wide area network or over the internet by computer system 26.

In step 310, each image is analyzed to determine the best season match for that image. In order to calculate such a match, well known algorithms for identifying objects, colors, textures, or shapes appearing in each image are utilized in step 306. Although not described in detail herein, such algorithms are described in, for example, Digital Image Processing: PIKS Scientific Inside by William K. Pratt, 4th edition, copyright 2007 by John Wiley and Sons, ISBN: 978-0-471-76777-0, and U.S. Pat. No. 6,711,293, to Lowe, which defines an algorithm for object recognition and an aggregate correlation that is useable as a confidence value, which is incorporated herein by reference in its entirety. The result of the algorithms includes a confidence value that a detected object, color, texture, or shape in each digital image is accurately identified. Table 1, in which each Element in the association set is searched for in each digital image, provides a list of Elements to search for (first column) as well as table cells for entering the results of the search. Thus, a preferred embodiment of the present invention includes the step of reading the table entries under the Elements column and, for each Element, applies the well known object identification algorithms identified above to calculate for each Element a confidence value (Cᵢ) that an object, color, texture, or shape corresponding to the current Element has been detected in the current digital image. The value is entered in the table for that particular Element.

The table separately charts a prevalence value (Pᵢ or Pᵢⱼ) for each season corresponding to each Element which indicates strength of association between the Element and the season. This prevalence value is separately determined and can be provided in the table and stored in the computer system. The prevalence values can be determined in a variety of ways. They can be calculated based on historical searches of large numbers of digital images, or they can be entered and stored by individuals providing a subjective value that indicates an association between such an Element in an image and its correspondence to a season. For example, a detected beach scene can have a high prevalence value for the season “Summer” or for the holiday season “4th of July” and a low prevalence value for the season “Winter” or for the holiday season “Christmas.” Such prevalence values are compiled and stored with the table. Some Elements may have an association of zero with a particular season. Other Elements may have a varying value for every season column listed. Prevalence values can be culturally, temporally, or geographically dependent. An Element having an equal prevalence value for each season listed in the columns would not serve to differentiate the current image for association with a season. Stored prevalence values can be reused as desired by a user. The user can also enter such prevalence values to be stored in the association set. In this case, a user who is familiar with his or her collection of digital images can enter realistic prevalence values for each season for Elements appearing in his or her image collection which will result in more accurate season identifications for his or her image collection.

Continuing with the algorithm for implementing step 310, the Table 1 cells can now be calculated and final values entered therein, for Wseason, using Eqn. 1 as shown below. In a preferred embodiment of the present invention, the confidence value for each Element is multiplied by the prevalence value for each season to determine the value for each cell in Table 1, that is, Wi. The Table 1 cell values are then added for each Season column to determine a weight value for the digital image, Wseason, as described below. The preferred embodiment of the present invention is not limited only to this algorithm. Table 1 can be easily constructed as a multi-dimensional data structure to include more inputs for calculating cell values. Thus, the formula for determining Wseason can be implemented using Eqn. 3 shown below. As an example, a user's image collection that includes metadata that identifies user favorite images can be used as input to this equation and a resulting Wseason value will be increased for user favorite images. Other image values can also be included for such calculations. These inputs can be optionally used for Table 1 or for Table 2, as described below. After all Elements have been searched for in the digital image set, or in a user selected group of digital images, under consideration, the Total Wseason values are added for each column corresponding to a season as shown in the last row of Table 1.

The Total Wseason values entered into Table 1 are used in step 320 for populating Table 2. Each row in Table 2 corresponds to each image under consideration and contains the Total Wseason value obtained for a particular image from step 310. The last column of Table 2 is used to identify which season, of the seasons identified in the first row, is best associated with the corresponding image listed in the first column. The last row of Table 2 is used to identify which image, of the images identified in the first column, is best associated with a particular season listed in the first row. These last columns and rows are simply the highest values obtained from the respective rows and columns. Images tagged as user favorites can optionally be weighted more heavily and the inputs for those tags used when calculating the Max values in Table 2, rather than using them in calculating Table 1 cell values.

In step 325, the image with the largest value from the last row of Table 2 is selected as best representing the season. The last column values can be used, optionally, to select a season that best correlates to an image. An optional step, step 326, includes the step of ranking multiple images for each season according to its calculated values as provided in Table 2. Preference for inclusion in an event associated with a season can then be given to the higher valued images in step 325. The resulting weighting can be used, as described above, to order the digital images in a seasonal group (e.g. the columns in Table 2), so that the digital image with the highest weighting is preferred. The selected image can then be employed in the product (step 330).

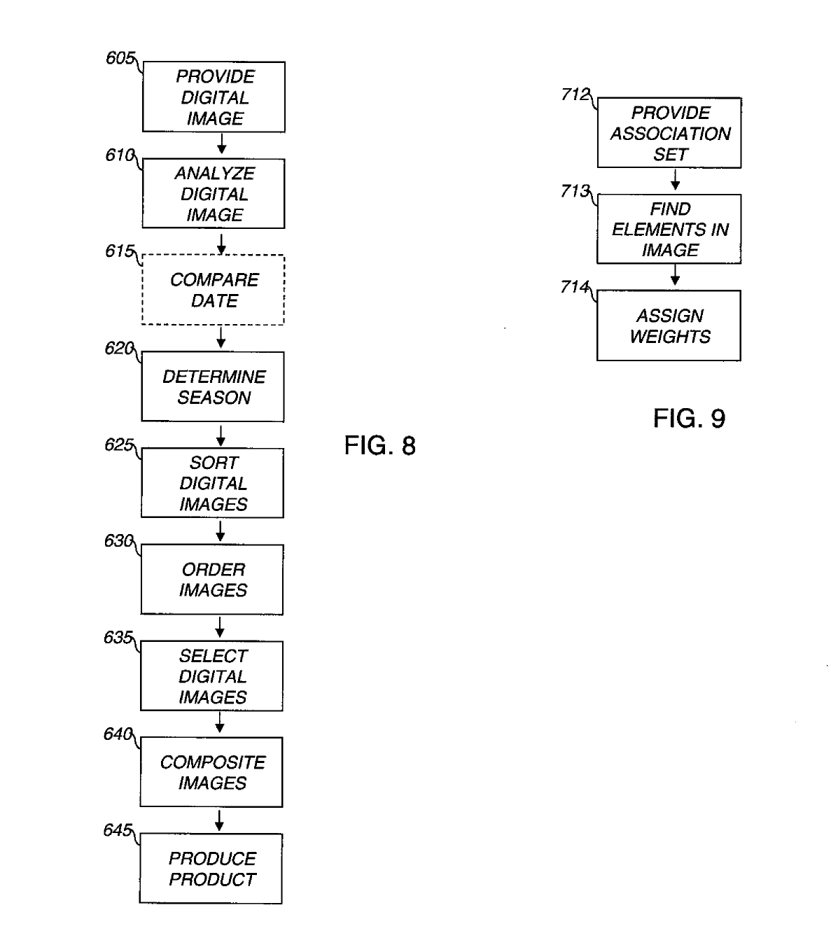

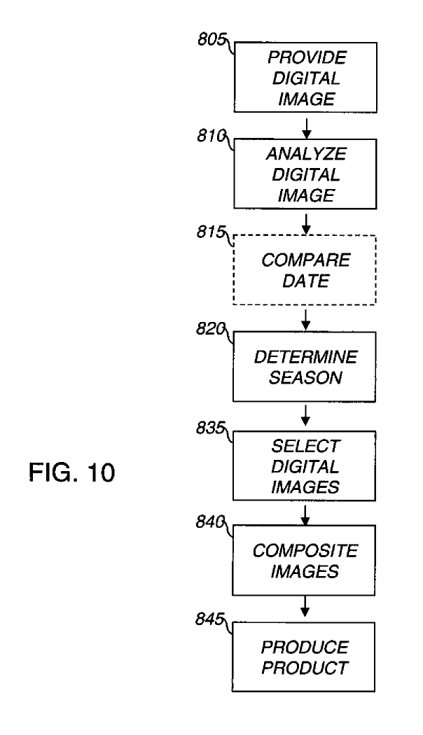

Referring to FIGS. 8 and 10, in an embodiment of the present invention, at a high level the present computer implemented method includes providing the digital images (steps 605, 805), analyzing the pixels of the digital images in step 610, 810 to determine a season depicted by the digital images. In step 625, the digital images can be sorted into one or more seasonal groups corresponding to the determined seasons that can be associated with distinct, different events. An event for a group of images can be determined in a variety of ways known in the art, for example by common dates, common objects, and common individuals within a scene. An analysis of the distribution of images through time is also useful in identifying separate picture-taking events.

Another preferred embodiment of the present invention includes the optional step 615, 815 of comparing the determined season stored in association with each of the digital images, via the method described below, to date or location data associated with the digital images that are also included as metadata stored in association with each digital image file. Digital cameras include software that provides metadata associated with captured images that record details concerning the image capture, such as camera settings, the date of capture, and the location of capture, either through automated devices (e.g. an internal clock or global positioning system) or via user input. In another preferred embodiment of the present invention, metadata associated with each image is included in the step 620, 820 of determining the season of a digital image, wherein the metadata is read by the computer system and a corresponding season is associated with the digital image based on such metadata.

An image-associated date can then be associated with a season. This association could be a simple month-to-season correspondence. Location information can also be used to improve accuracy when determining a season based on date information. Note however, that for some image products, the date may not be an adequate predictor of the suitability of a digital image for an image product. For example, it is desired to provide an image that is representative of a season. However, an image taken at a time during the season is not necessarily representative of the season. It is also possible that the date may be incorrect if a user has not entered and stored the correct current date. Thus the associated metadata date is helpful in selecting a suitable image but is not necessarily indicative or completely definitive.

Similarly, an associated location can be associated with a season, especially in combination with a date. For example, it may be known that a location is associated with a season (e.g. a person is often in a particular place during a particular season). Hence, images associated with the place are associated with the season. As with the date, however, such association does not necessarily mean that an image is suitable to represent a season for a particular image product, particularly if it is desired that the image be representative of a season. For example, an image captured indoors might not contain any visual details indicative of a specific season.

Once the season of an image is determined, it is sorted (step 625) into one or more seasonal groups corresponding to the determined seasons that can be associated with different distinct events. In the simplest case, a single seasonal group or distinct event has only one member, a single image. For example, it may be desired simply to determine whether a digital image corresponds to a desired season. In this case, the sorting is by default because there is only one candidate image and it requires no list construction. Such a case is considered to satisfy a sorting step and is included in a preferred embodiment of the present invention. In more complex situations, for example in creating a one-year calendar, a plurality of images are examined and might be determined to belong to a plurality of seasonal groups or distinct events, each group or event of which could include multiple images. In another preferred embodiment of the present invention, the images in a seasonal group or event are ranked (step 630) by image quality, user preferences, or the degree to which the image is representative of a season or event, or some desired combination of these characteristics. This is described in more detail below with reference to the valuation calculations. A variety of metrics can be employed to order, rank, or sort the images in order of image quality, for example, sharpness and exposure. Affective metrics (such as a user's favorite images, as determined by other well-known means or, known by a user's identifying and storing particular images as favorites) are employed in making the image selection (step 635, 835) as well. Thus, desired digital images that have a greater quality than digital images having a lesser quality are preferentially selected.

Images representing a variety of seasons can be employed with a preferred embodiment of the present invention. Typical seasons include weather-related seasons of the year, for example winter, spring, summer, autumn (fall), dry season, rainy (wet) season, harmattan season, monsoon season, and so forth. Holiday seasons can also be represented, for example Christmas, Hannukah, New Year's Valentine's Day, National Day (e.g. July 4 in the United States), and Thanksgiving. Seasons include personal holidays or celebrations, including birthdays and anniversaries.

The analysis step (610, 810) of a method of a preferred embodiment of the present invention is facilitated by providing an association set, such as depicted in Table 1, that includes Elements such as objects, colors, textures, or shapes that might be found in a digital image undergoing analysis for selective use. Each object, color, texture, or shape listed in the Element column of Table 1 has an associated prevalence value corresponding to each of a number of seasons, also listed individually in columns corresponding to each season. Thus, an object listed in the first column of elements has a plurality of prevalence values listed in the row to the right of the Element indicating its magnitude of correlation to each particular season column. For example, if an association set includes “Christmas tree” in its column of Elements a corresponding prevalence value under a “Winter” season column will be higher than its prevalence value under a “Summer” season column. Similarly, if a plurality of Season columns includes holiday seasons, then an image having a detected Christmas tree will have a higher prevalence value in its Christmas season column than in its Easter season column. This association set is formed by ethnographic or cultural research, for example by displaying a large number of images to members of a cultural group. The members then relate objects found in each scene to each season and ranking the object importance to provide prevalence values. The aggregated responses from many respondents can then be used to populate the association set. As noted above, the prevalence values can be culturally, temporally, or geographically dependent. For example, Christmas is celebrated in the summer in the southern hemisphere.

During an analysis step, the programmed computer system accesses a previously stored association set and searches each digital image for Elements identified therein. If an object, color, texture, or shape is found within a digital image that is in the association set, the digital image is scored with respect to each of the seasons that might correspond with the found Element. The resulting score is the prevalence value as between the found object (Element) and the Season (column) under analysis. Various Elements listed in the association set may be found in each of a plurality of images, resulting in Total Prevalence values that are the sum of prevalence values in each Season column. The Season column having the highest Total Prevalence value is the Season associated with a particular image. Such scored images are sorted and stored into seasonal groups by assigning the digital images to the seasonal group corresponding to its associated season.

The following list provides some association sets useful for implementing the analysis step in different countries or cultures. Note that different cultures have widely differing associations, so that an association set is culturally dependent. The color white can be associated with winter, Christmas, anniversaries, weddings, and death. The color green can be associated with Christmas, Spring, St. Patrick's Day, and Summer. The color red can be associated with Christmas, Valentine's Day, and National Day. The color orange can be associated with autumn, thanksgiving, and National Day. Combinations of colors are associated with a season, for example red, white, and blue are the national colors of several countries and are associated with those countries' National Day. Flesh tones can be associated with summer, and seasons can be associated with digital images containing people, for example anniversaries and birthdays in which images of people are prevalent. Objects and displays can be part of association sets: Fireworks can be associated with summer, National Day, and New Year's Day, while candles can be associated with birthdays, anniversaries, and personal celebrations. Snow can be associated with winter and Christmas in northern climates, while green grass can be associated with spring and summer. Water can be associated with summer and holidays while flowers can be associated with anniversaries and Spring. According to a preferred embodiment of the present invention, association sets are not limited to the foregoing examples.

As these examples make clear, associating a digital image with a season involves a number of calculations as well as evaluating the metadata discussed above. A plurality of objects, colors, textures, or shapes listed in the association set can be found in a single digital image. Furthermore, an object, color, texture, or shape can be associated with more than one season. Nonetheless, prevalence value results define which season or seasons are most highly associated with a particular image. In the event that an image is equally associated with a plurality of different seasons in an association set, a random method can be used to categorize the image into one of the seasons. Another option is to weight particular Elements as more indicative of a season and select a highest prevalence value of one of the Elements as the associated season.

The confidence value is an accuracy indicator of how likely the found element really is the listed element and the prevalence value indicates how strongly the listed element is associated with the season.

The size of the element and the location of the element within the image also affect the prevalence value so that, in a preferred embodiment of the present invention, the prevalence value is a function rather than a single number. If both the confidence and prevalence values are low, the weight given to the seasonal assignment is likewise low. If both the confidence and prevalence values are high, the weight given to the seasonal assignment is high. In a preferred embodiment of the present invention, the weight value is a product of the confidence value and the prevalence value, as described in more detail below.

For example, a seasonal assignment weight value for a digital image for a given season is expressed as:

Wseason=ΣCi*Pi Eqn. 1

where Ci is the confidence value that each found element i in the digital image is the listed element in the association set and Pi is the prevalence value for each listed element in the association set for each season. A C value can be determined using image processing calculations known in the image processing art. For example, a very specific object of a known size can be found by a two-dimensional convolution of an object prototype with a scene. The location of the largest value of the convolution represents the location of the object and the magnitude of the value represents the confidence that the object is found there. More robust methods include scale-invariant feature transforms that use a large collection of feature vectors. This algorithm is used in computer vision to detect and describe local features in images (see e.g. U.S. Pat. No. 6,711,293 entitled “Method and apparatus for identifying scale-invariant features in an image and use of same for locating an object in an image” identified above). An alternative method can employ Haar-like features. Thus, Elements that are not found in the digital image have a C value of zero. Elements that are found in the digital image with a high degree of certainty, or confidence, have a C value of nearly 1. If the found element is highly correlated with a season, the P value is high. If the found element is not correlated with a season, the P value is low. The calculation is repeated for each Element for each season under evaluation. Each digital image under evaluation is analyzed and sorted into the seasonal group corresponding to the highest Wseason value. The images within each seasonal group are then ranked within the seasonal group by their Wseason values. The digital image with the highest Wseason value within a seasonal group is the preferred digital image for that season, e.g.

Pref_{group}=MAX(Wseason) Eqn. 2

The preferred image within a group is thus the image with the highest Wseason ranking and is selected for use in a multi-image multi-event image product. As mentioned previously, if two images have equal Wseason values, a random selection procedure or a weighted selection procedure (e.g. preferred Element value) can be implemented to select a digital image.

The ranking can also include additional parameters or factors such as date and location correlation, or user preference (favorites). For example,

Wseason=ΣCi*Pi*Di*Li*Fi Eqn. 3

where Di is a date matching metric, Li is a location matching metric, and Fi is a preference matching metric. The Di value can be obtained from image capture devices that include clocks such as some digital cameras or by user input. The Li value can be obtained from image capture devices that include global positioning systems such as some digital cameras or by user input. The Fi value can be obtained from user input or records of image use, for example, the more frequently used images being presumed to be favored.

While the combinations shown in the equations above are multiplicative, other combination formulas are possible, for example linear or a combination of linear and multiplicative formulas.

In a preferred embodiment of the present invention, the association set is organized as a table, and a table can be generated for each image for the step of image analysis:

TABLE 1

| Element | Season 1 | Season 2 | Season 3 | Season 4 |
|---|---|---|---|---|
| Element 1(C₁) | P₁₁ | P₁₂ | P₁₃ | P₁₄ |
| | Wᵢ = C₁ *P₁₁ | Wᵢ = C₁ *P₁₂ | Wᵢ = C₁ *P₁₃ | Wᵢ = C₁ *P₁₄ |
| Element 2(C₂) | P₂₁ | P₂₂ | P₂₃ | P₂₄ |
| | Wᵢ = C₂ *P₂₁ | Wᵢ = C₂ *P₂₂ | Wᵢ = C₂ *P₂₃ | Wᵢ = C₂ *P₂₄ |
| Element 3(C₃) | P₃₁ | P₃₂ | P₃₃ | P₃₄ |
| | Wᵢ = C₃ *P₃₁ | Wᵢ = C₃ *P₃₂ | Wᵢ = C₃ *P₃₃ | Wᵢ = C₃ *P₃₄ |
| Element 4(C₄) | P₄₁ | P₄₂ | P₄₃ | P₄₄ |
| | Wᵢ = C₄ *P₄₁ | Wᵢ = C₄ *P₄₂ | Wᵢ = C₄ *P₄₃ | Wᵢ = C₄ *P₄₄ |
| Total | Wseason = | Wseason = | Wseason = | Wseason = |
| | ΣCᵢ*Pᵢ | ΣCᵢ*Pᵢ | ΣCᵢ*Pᵢ | ΣCᵢ*Pᵢ |

In Table 1, the prevalence value associated with each element and season is illustrated. The first subscript is the element value and the second subscript is the season. The P value is a measure of the strength of the association between the element and the season and is valued between zero and 1. The C value for each Element is the confidence value that the Element is accurately identified in the digital image.

Note that this method can be used generally to create a table relating images to seasons, as shown below for Table 2. The row Total from example Table 1 comprises the four column values under seasons 1 through 4 for each row Image 1 through Image n in Table 2. Finally, the last column in Table 2 identifies which of the seasons for each image, Image 1 through Image n, has obtained the highest seasonal determination value (MAX(Wᵢⱼ)) and is used as the season associated with that image.

TABLE 2

| Image | Season 1 | Season 2 | Season 3 | Season 4 | Best Season Match |
|---|---|---|---|---|---|
| Image 1 | W₁₁ | W₁₂ | W₁₃ | W₁₄ | MAX(W₁ⱼ) |
| Image 2 | W₂₁ | W₂₂ | W₂₃ | W₂₄ | MAX(W₂ⱼ) |
| Image 3 | W₃₁ | W₃₂ | W₃₃ | W₃₄ | MAX(W₃ⱼ) |
| Image 4 | W₄₁ | W₄₂ | W₄₃ | W₄₄ | MAX(W₄ⱼ) |
| Best Image | MAX(Wᵢ₁) | MAX(Wᵢ₂) | MAX(Wᵢ₃) | MAX(Wᵢ₄) | |
| Match | | | | | |

In Table 2, the weighting for each image in an image set for each season is shown as calculated in the equations and Table 1 above. The largest value in a season column specifies the best image match for that season. The largest value in an image row specifies the best seasonal match for an image. Referring to FIG. 9, the association set is provided in step 712, elements in an image found in step 713, and weights assigned in step 714 to each found element. A combination of different weights can be used to determine the associated season.

Referring to FIGS. 8 and 10, in this case the provision of the digital image (step 605, 805) is the same step as selecting the digital image (if only one image is provided). If multiple images are provided, some selections take place. Once selected, the digital image is analyzed (step 610, 810), a date is optionally compared (step 815) and a season determined (step 620, 820). Preferred digital images can be selected (step 635, 835), composited into an image product (step 640, 840), and produced (step 645, 845).

The present invention can be used in a variety of image-based products. In some cases, the products have a predetermined number of images, for example template openings in pages. In this case, the number of relevant digital images selected is chosen to correspond to the number of product images. In an alternative embodiment, the number of images in a product is not predetermined and can be adjusted depending on the type of images available, for example size-dependent resolution or portrait vs. landscape, and the preferences of a customer who can specify or modify the layout of images on a page, for example in a photo-book. In this case, the number of relevant digital images selected can specify the number of product images.

The method of the present invention can be used in a computer system for making a multi-image multi-event product. The computer system can support both the methods described with reference to FIG. 4 and with reference to FIG. 5. As shown in FIGS. 1, 2, and 3, the computer system can include a server computer connected to one or more remote client computers through a computer network. The server or client computes can include software for receiving a plurality of digital images, software for enabling the selection of first and second dates to define a date range and for selecting a theme, and software for identifying relevant digital images that are within the date range and relevant to the theme. The computer system can further include software for segmenting the relevant digital images into distinct events, each distinct event including one or more different relevant digital images, software for selecting at least one relevant digital image from each of at least two different distinct events, software for incorporating the selected images into a multi-image multi-event product, means for communicating or printing the multi-image multi-event product.

The software can be stored on one computer in a network, e.g. the server computer and at least a portion of the software can be transmitted to a remote client computer where the software portion executes. The transmitted software can provide a user interface for interacting with a user to enable the selection of first and second dates to define a date range and for selecting a theme. The software can be enabled within a browser executing on a client computer and receiving instructions from a remote server computer.

In one embodiment of the present invention, a season is a distinct event and the software can automatically analyze the pixels of the one or more digital images to determine which one of a plurality of seasons is depicted by each of the one or more digital images. The software can comprise an association set including items selected from the group consisting of objects, colors, textures, and shapes, wherein each of the objects, colors, textures, or shapes has one of the plurality of seasons associated therewith. Each of the one or more digital images can include an item, or multiple items, from the association set. The items can each include a weighted value that indicates a likelihood that each found item matches the item in the association set. The weighted value can indicate a prevalence of each found item in its associated season.

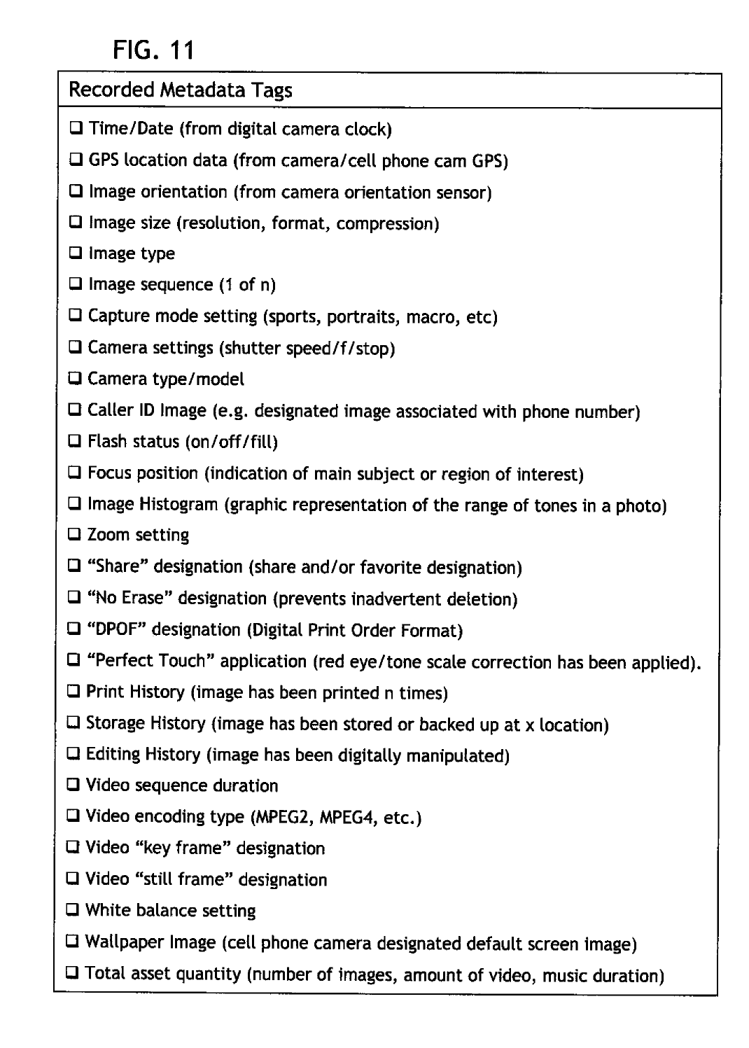

Referring now to FIG. 11, a list of extracted metadata tags obtained from image acquisition, image editing and utilization systems including cameras, cell phone cameras, personal computers, digital picture frames, camera docking systems, imaging appliances, networked displays, and printers. Extracted metadata is synonymous with input metadata and includes information recorded by an imaging device automatically and from user interactions with the device. Standard forms of extracted metadata include time/date stamps, location information provided by global positioning systems (GPS), nearest cell tower, or cell tower triangulation, camera settings, image and audio histograms, file format information, and any automatic image corrections such as tone scale adjustments and red eye removal. In addition to this automatic device centric information recording, user interactions can also be recorded as metadata and include “Share”, “Favorite”, or “No-Erase” designations, “Digital print order format (DPOF), user selected “Wallpaper Designation” or “Picture Messaging” for cell phone cameras, user selected “Picture Messaging” recipients via cell phone number or e-mail address, and user selected capture modes such as “Sports”, “Macro/Close-up”, “Fireworks”, and “Portrait”. Image utilizations devices such as personal computers running Kodak Easy Share™ software or other image management systems and stand alone or connected image printers also provide sources of extracted metadata. This type of information includes print history indicating how many times an image has been printed, storage history indicating when and where an image has been stored or backed-up, and editing history indicating the types and amounts of digital manipulations that have occurred. Extracted metadata is used to provide a context to aid in the acquisition of derived metadata.

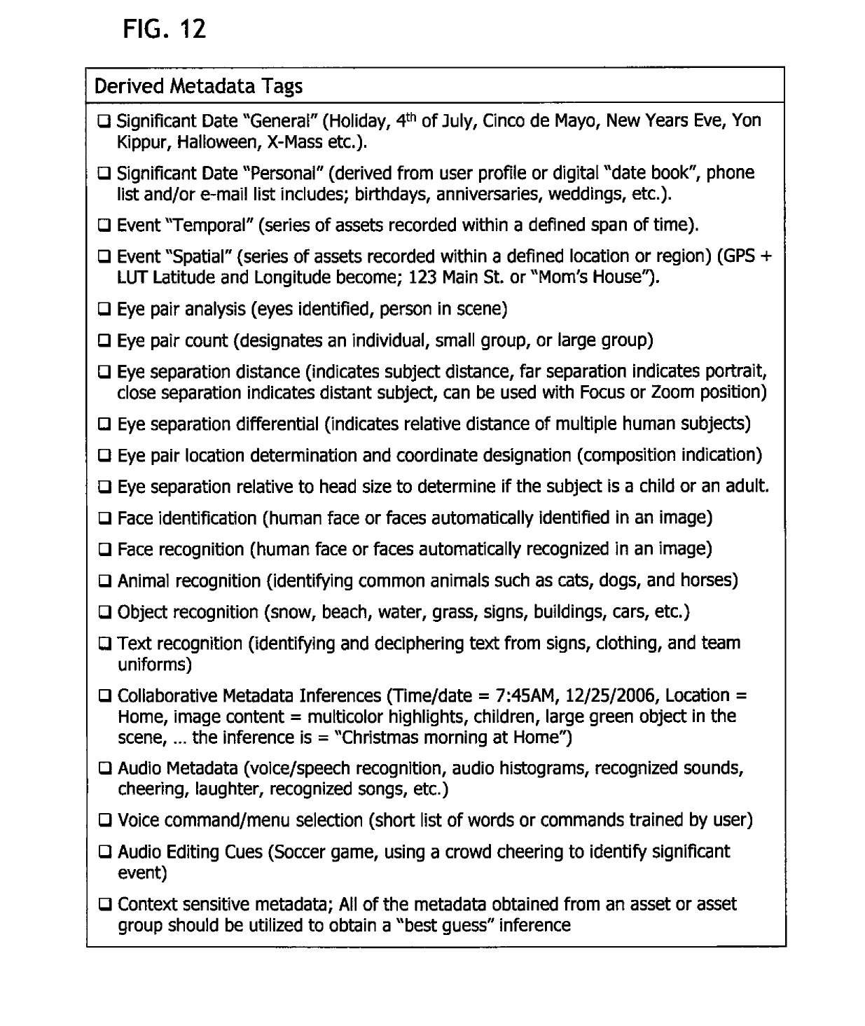

Referring now to FIG. 12, a list of derived metadata tags obtained from analysis of image content and existing extracted metadata tags. Derived metadata tags can be created by image acquisition, image editing and utilization systems including; cameras, cell phone cameras, personal computers, digital picture frames, camera docking systems, imaging appliances, networked displays, printers. Derived metadata tags can be created automatically when certain predetermined criteria are met or from direct user interactions. An example of the interaction between extracted metadata and derived metadata is using a camera generated image capture time/date stamp in conjunction with a user's digital calendar. Both systems can be collocated on the same device as with a cell phone camera or can be dispersed between imaging devices such as a camera and personal computer camera docking system. A digital calendar can include significant dates and events of general or special interest such as: Seasonal Identification and events significant to a person or group as described herein, Cinco de Mayo, Independence Day, Halloween, Christmas, and the like and significant dates of personal interest such as “Mom & Dad's Anniversary”, “Aunt Betty's Birthday”, and “Tommy's Little League Banquet”. Camera generated time/date stamps can be used as queries to check against the digital calendar to determine if any images or other files were captured on a date of general or personal interest. If matches are made the metadata can be updated to include this new derived information. Further context setting can be established by including other extracted and derived metadata such as location information and location recognition. If, for example, after several weeks of inactivity a series of images and videos are recorded on September 5^{th} at a location that was recognized as “Mom & Dad's House”. In addition the user's digital calendar indicated that September 5^{th} is “Mom & Dad's Anniversary” and several of the images include a picture of a cake with text that reads, “Happy Anniversary Mom & Dad”. Now the combined extracted and derived metadata can automatically provide a very accurate context for the event, “Mom & Dad's Anniversary”. With this context established relevant theme choices would be made available to the user significantly reducing the computer workload required to find an appropriate theme. Also labeling, captioning, or blogging, can be assisted or automated since the event type and principle participants are now known to the system, wherein a digital cameras is an example of a system.

Another means of context setting is referred to as event segmentation as described above. This uses time/date stamps to record usage patterns and when used in conjunction with image histograms it provides a means to automatically group images, videos, and related assets into “events”. This enables a user or a computer system to organize and navigate large asset collections by event.

The content of image, video, and audio digital files can be analyzed using face, object, speech, and text identification and algorithms. The number of faces and relative positions in a scene or sequence of scenes can reveal important details to provide a context for the digital images. For example a large number of faces aligned in rows and columns indicates a formal posed context applicable to family reunions, team sports, graduations, and the like. Additional information such as team uniforms with identified logos and text would indicate a “sporting event”, matching caps and gowns would indicate a “graduation”, and assorted clothing may indicate a “family reunion”, and a white gown, matching colored gowns, and men in formal attire would indicate a “Wedding Party”. These indications combined with additional extracted and derived metadata provides an accurate context that enables the system to select appropriate images; detect, identify, find, or provide relevant themes, or any combination thereof, for the selected images, and to provide relevant additional images to the original image collection.

The invention has been described in detail with particular reference to certain preferred embodiments thereof, but it will be understood that variations and modifications are effected within the spirit and scope of the invention.

### PARTS LIST

24 data files
26 computer system
28 output system
29 printer
30 printer
32 printer
34 processor
35 I/O
38 sensor
39 portable memory
40 storage
42 hard disk drive storage
44 disk drive storage
46 portable memory card slot
48 removable portable memory card
50 memory card interface
52 remote memory system
54 communication system
56 remote display I/O
58 wireless input system I/O
58a user controlled input
58b user controlled input
58c user controlled input
66 local display I/O
68 wired user input system I/O
68a user control I/O
68b user controlled input
70 system
72 user
74 audio sensor
80 remote client computer
82 server computer
84 storage
86 display
88 graphic user interface
89 lenses
90 computer network
92 computer program
100 select start date step
105 select end date step
110 select theme step
115 provide digital images step
120 identify relevant images step
125 segment relevant images step
130 select relevant images step
135 incorporate selected images into product step
140 communicate product step
220 segment images into events step
225 select relevant events step
230 select relevant images step
300 access association set
305 access digital images step
306 analyze digital image step
310 calculate table entries step
320 find max value step
325 associate season step
326 rand images step
330 employ image in product step
340 print product step
345 deliver product step
350 email product
605 provide digital image step
610 analyze digital image step
615 compare date step
620 determine season step
625 sort digital images step
630 order images step
635 select digital images step
640 composite images step
645 produce product step
712 step
713 step
714 step
805 provide digital image step
810 analyze digital image step
815 compare date step
820 determine season step
835 select digital images step
840 composite images step
845 produce product step

1. A computer system for making a multi-image product, comprising:
a server computer connected to one or more remote client computers through a computer network;
a first software portion for selecting first and second dates to define a date range and for selecting a theme;
a second software portion for retrieving a plurality of digital images that includes digital images taken within the date range;
a third software portion for segmenting the digital images into distinct events, each distinct event including one or more different digital images;
a fourth software portion for identifying distinct events corresponding to the theme;
a fifth software portion for selecting at least one digital image from each of at least two distinct events;
a sixth software portion for incorporating the selected images into a multi-image product;
means for communicating or printing the multi-image product.

2. The computer system of claim 1, further comprising a seventh software portion that is transmitted to one of the remote client computers, the seventh software portion providing a user interface for interacting with a user to enable the selection of the first and second dates to define the date range and to select the theme.

3. The computer system of claim 1, wherein the software portions are stored on the server computer and some of the software portions are transmitted to one of the remote client computers where the transmitted software portions execute.

4. The computer system of claim 1, wherein a season of a year is a distinct event.

5. The computer system of claim 4, further including an eight software portion for automatically analyzing pixels of one or more of the digital images to determine which one of a plurality of seasons is depicted by the one or more of the digital images.

6. The computer system of claim 5, further including an association set that includes items selected from the group consisting of objects, colors, textures, and shapes, wherein each of said objects, colors, textures, or shapes has one of the plurality of seasons associated therewith.

7. The computer system of claim 6, wherein each of the one or more digital images includes an item from the association set.

8. The computer system of claim 6, further including a weighted value for each item detected in the one or more of the digital images.

9. The computer system of claim 8, wherein the weighted value indicates a likelihood that each item detected in the one or more of the digital images matches an item in the association set.

10. The computer system of claim 8, wherein the weighted value indicates a prevalence of each item, detected in the one or more of the digital images, in its associated season.

11. A computer system for automatically designing a multi-image product, comprising:
a memory for storing a plurality of digital image files, each digital image file including a digital image and metadata defining the included digital image;
a user interface for selecting first and second dates to define a date range, and for selecting a theme, wherein the date range and the theme are stored in the memory;
a first program portion for reading the metadata to find ones of the digital image files having both capture dates that are within the date range and image elements corresponding to the theme;
a second program portion for sorting the digital image files into distinct event groups, each distinct event group including one or more different digital image files, and for selecting at least one digital image files from each of at least two distinct event groups;
a third program portion for arranging the selected images into a multi-image product; and
means for delivering the multi-image multi-event product.

12. The computer system of claim 11, wherein the system includes means for downloading the user interface.

13. The computer system of claim 12, wherein the user interface is downloaded to the computer system and at least some of the program portions reside on a server.

14. The computer system of claim 11, wherein a plurality of seasons is each stored on the computer system as a distinct event.

15. The system of claim 14, further including a fourth program portion for analyzing pixels of a digital image to determine which one of the plurality of seasons is depicted by the digital image.

16. The system of claim 15, further including an association set stored in the memory, the association set including items selected from the group consisting of objects, colors, textures, and shapes, wherein each of said objects, colors, textures, and shapes has one of the plurality of seasons logically associated therewith.

17. The system of claim 16, wherein each of the digital images depicts an item from the association set.

18. The system of claim 16, further including a weighted value, associated with each item, stored in the memory.

19. The system of claim 18, wherein the weighted value indicates a likelihood that its associated item in the association set matches an item detected in the digital image.

20. The system of claim 18, wherein the weighted value indicates a prevalence value, of each item detected in the digital image, for its associated season.
